(19) United States
(12) Patent Application Publication
(10) Pub. No.: US 2024/0352782 A1
(43) Pub. Date: Oct. 24, 2024

(54) CLOSING DEVICE AND METHOD FOR CLOSING A DOOR

(71) Applicant: MAGNA CLOSURES INC., Newmarket (CA)

(72) Inventors: Martin DANNEMANN, Newmarket (CA); Sebastian PRENGEL, Newmarket (CA)

(21) Appl. No.: 18/763,374

(22) Filed: Jul. 3, 2024

Related U.S. Application Data
(63) Continuation of application No. 16/732,995, filed on Jan. 2, 2020.

(51) Int. Cl. E05F 15/70

(52) U.S. Cl. CPC E05F 15/70; E05Y 2900/531

(57) ABSTRACT

A method and a device for closing a door on a door opening of a vehicle are provided. The closing device includes a seal formed between the door and the door opening for separating an interior space and an exterior space from each other when the door is in a closed position. The device also includes a door drive for moving the door and a controller coupled to the door drive for controlling movement of the door based on an operating request of a user. The controller includes a condition monitoring unit configured to determine and use at least one variable state variable chosen from the group consisting of the device, the door, the door opening, and the installation environment of the door. The controller is configured to generate a value of at least one closing parameter for closing the door depending on the at least one variable state variable.

### CROSS-REFERENCE TO RELATED APPLICATIONS

This application is a continuation of U.S. application Ser. No. 16/732,995 filed Jan. 2, 2020 titled “Closing Device and Method for Closing a Door”, the contents of which are hereby incorporated by reference as if reproduced in full below.

### FIELD

The present invention relates to devices for closing a door, and, in particular, to closing devices for closing a door on a door opening of a door system for a motor vehicle with at least one such door system and a method for closing the door on the door opening.

### BACKGROUND

This section provides background information related to the present disclosure which is not necessarily prior art.

During closing and subsequent locking of vehicle doors, closing forces and torques can vary greatly in different operating situations of the motor vehicle due to a variety of reasons. For example, an inclination of the road may cause difficulty opening or maintaining the driver's door in an open position when the vehicle is parked. Consequently, a significantly higher or lower closing torque may be required than is the case for closing the door on a level surface.

In addition, the door may compress and rest against an at least partially circumferential sealing element arranged on the door and/or on the door frame or opening. Thus, the required closing torque may also depend on material properties of such a sealing element.

Additionally, there are cases of operation in which the interior of the vehicle is hermetically sealed by the sealing element when the door is closed and all other doors and windows are closed at the same time. However, such a lack of ventilation can adversely affect door closing.

In view of the above, there remains a need to develop improved devices and methods for closing a door to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a device for the closing of a door at a door opening and to provide an improved method for closing a door at a door opening that addresses and overcomes the above-noted shortcomings.

According to another aspect of the disclosure, a device for closing a door on a door opening of a door system of a vehicle or other closed space, (hereinafter also referred to as the closing device) is provided. The device is arranged in particular at the door and/or at the door opening. A seal is formed between the door and the door opening and at least partially surrounds the door opening and when the door system is in a closed position or state. The seal demarcates an interior space and an exterior space of, for example a vehicle or a room, from each other in an installation environment of the door. Normally, the seal comprises a sealing element disposed on the door and/or on the door opening. The device also includes a door drive, in particular a door drive which, by means of a suitable transmission, is provided with an electrical motor or actuator connected to a door frame and to the door itself. The door drive, for example, can be a linear actuator for closing and opening the door. In addition, the device includes a controller for controlling the door drive based on an operating request of a user. Specifically, the operating request can include actuation of a control element and/or by moving the door by the user. The user request can correspond to at least one predetermined value of at least one closing parameter.

The controller has a condition monitoring unit that is configured to determine an amount of at least one variable state variable of the device, the door, the door opening, and/or the installation environment of the door. The controller is configured to generate a value of the at least one closing parameter for closing the door depending on the at least one variable state variable determined.

The at least one variable state variable that is monitored can, for example, be related to the seal, such as, in particular, a seal temperature or a seal ageing condition. The variable state variable can also, for example, correspond with the installation environment, such as, for example, an ambient temperature. Thus, a condition monitoring unit of the controller can also be used to monitor, for example, the ambient temperature with a sensor such as a temperature sensor and may also be coupled to a readout or display device for displaying the state variable determined by the controller. So, the controller may use a stored temperature model depending on the variable state variable.

The value of the closing parameter, particularly a closing torque and/or a closing speed can be determined and/or adjusted based on the variable state variable. If necessary, a required closing moment can also be converted into a required closing speed, in particular additionally depending on the weight of the door and/or other factors.

According to a further aspect, a door system, especially in a motor vehicle or in a building can include a door, a door opening and a device for closing the door at the door opening.

According to another aspect, a motor vehicle is provided with at least one, in particular two or four, door systems in accordance with aspects of the disclosure.

According to a further aspect, a method for closing a door on a door opening of a vehicle is also provided. The method includes the step of i) determining an operating request for closing a door. The method can continue with the step of ii) determining the position of the door or another at least one variable state variable using a condition monitoring unit. The method can also include the step of iii) determining a value of at least one closing parameters as a function of the at least one variable state variable determined by a controller to which the condition monitoring unit is connected. The method proceeds by iv) controlling a door drive for closing the door in accordance with the determined value using the controller and v) closing the door according to the control using the door drive.

Among other things, the disclosure is based on the insight that, depending on the closing forces when closing a door with a seal differ based on the state of the door seal. The condition of the door seal is defined in particular by the stiffness of the gasket or sealing element material, the stiffness in turn (especially with elastic sealing elements) is strongly dependent on the current temperature of the sealing element material and also of an ageing condition of the sealing element.

In addition, the disclosure is based, among other things, on the knowledge that a large number of other variable influencing factors influence the required closing force. For example, among other factors, a condition of the vehicle ventilation, of the other doors and windows of the vehicle affect displaceability of the air in the passenger compartment of the vehicle. If, for example, a window is open, the closing device only has to apply a very small additional force when closing the door in order to compress the air inside the vehicle. In contrast, if for example, a recirculation valve is closed and at the same time all other doors and windows are closed, the required additional force, is relatively high.

The disclosure is additionally based, among other things, on the idea of determining the relevant influencing factor(s) on the force required to reliably close the door, to determine and/or monitor the door opening and to determine necessary closing parameters (e.g., one closing moment and/or one closing speed) on the basis of the results of monitoring and/or to adapt accordingly. Depending on the application, a single state variable must be of such dominant relevance that it does not require any further state variable; however, it may also be necessary to monitor several state variables.

Such an adaptation of the closing parameter(s) (e.g., according to the maxim “as little as possible, as much as necessary”, or in the meaning of a “sound design” when closing the door) provides reliable closing of the door with minimal force. This leads to improved door closing noise by avoiding unnecessary door slamming. If necessary even the seal or sealing element can be designed for continuous load without consideration of larger load peaks, as door slamming forces are reduced or eliminated.

According to an aspect, the controller has a state calibration unit, which is configured to use an amount of at least one substantially constant state variable (also referred to as a constant or constant state variable) of the device, the door, the door opening, and/or the installation environment of the door. The controller uses such an amount of the at least one constant state variable to determine or adjust a value of at least one closing parameter, in particular a closing speed and/or a closing torque to close the door, during operation of the closing device. This allows influencing factors from environmental properties, such as the vehicle including, but not limited to material properties and/or combinations to be determined and included in the calculation of closing parameters to provide more accurate control.

According to another aspect, the condition monitoring unit and/or state calibration unit includes or is in communication with at least one suitable sensor arrangement for measuring of at least one state variable. Depending on the variable state variable that is monitored, the following sensor types may, for example, include, but are not limited to: a) an acceleration sensor for detecting a spatial orientation of the door and/or a vehicle, b) a timer for determining an age of the seal. (the timer of course does not have to be accurate within a narrow range and can allow the monitoring of a time value, for example, an ageing condition of a sealing element), and/or c) a position sensor, in particular an incremental encoder or a motor field monitor or an image acquisition sensor with element recognition. The position sensor can be used for example to c1) detect a door position, in particular an opening angle of the door, or c2) sense a position of a recirculation valve and/or a vehicle window or a vehicle door.

According to an aspect, the sensor arrangement includes a temperature sensor located on or near the sealing element and/or access is provided to the detected values of other temperature sensors inside and/or outside the vehicle. The temperature sensor and/or the detected values are used to compensate for the temperature-dependent change in the stiffness of the sealing element for the most commonly used elastic seals. The provision of one or the other sensor enables an adaptation of the device to state variables relevant in various applications.

For the consideration of stored operating models, user inputs, and/or the sensor values of the vehicle in a vehicle control unit and/or the controller of the closing device, the condition monitoring unit and/or the state calibration unit is in communication with a suitable input device, such as, but not limited to a keyboard, a touch input or similar, according to an aspect. In addition, the controller can include a memory or database (e.g., storing an operating model) that may be queried for comparison with stored values the state variable and/or for querying the characteristics of a state variable in a model of the controller or memory that can include other factors with expressions or amounts of the state variable in relation to each other.

The input device can also be used for making calibration inputs and/or involve the user. The operating or operational model of the state variable can be used for the monitoring of variable state variables and/or for the calibration of constant state variables.

In order to be able to use the closing parameter(s) according to the characteristics of the state variable(s), the operating request is determined and the characteristic value of the state variable is determined many times per second. Depending on these determinations, the closing of the door is controlled in real time, in particular by based on the last determined value of the closing parameter, depending in each case on from the last determined operating request and from the last determined value of the closing parameter (e.g., the last determined value of the closing parameter may be adjusted based on the operating request and state variable(s)).

According to yet another aspect of the disclosure, a system for a motor vehicle or a building including a plurality of door systems each including one of a plurality of doors at one of a plurality of door openings is provided. The system includes a plurality of seals each formed between the one of a plurality of doors and the one of the plurality of door openings for separating an interior space of the vehicle or building and an exterior space from each other in an installation environment when each of the plurality of doors is in a closed position. The system also includes a plurality of door drives for moving the plurality of doors to the closed position. The system additionally includes at least one controller coupled to the plurality of door drives for controlling movement of the plurality of doors based on an operating request of a user. The at least one controller comprises a condition monitoring unit configured to determine and use at least one variable state variable of the door system chosen from the group consisting of the plurality of doors, the plurality of door openings, and the installation environment of the plurality of doors. The at least one controller is configured to generate a value of at least one closing parameter for closing the plurality of doors depending on the at least one variable state variable determined.

According to an aspect of a disclosed method, an additional value that can be considered by the controller is at least one substantially uniformly pronounced state variable or constant state variable and the value of the closing parameter is additionally determined as a function of such a constant state variable. In order to adapt the closing parameters, a number of relevant influencing factors are taken into account and the value of the closing parameter depends on the characteristics of several variable and/or constant state variables. In order to adjust the closing parameters, a determination of the value of the closing parameter includes adjusting a previously determined value of the closing parameter as a function of the state variable(s). Specifically, an adjustment factor is multiplied and/or increased by an adjustment contribution or reduced in size. Among other things, this also allows a simple adjustment of the existing control for actuated doors.

Depending on the influencing factor or factors in the respective application, one or more variable state variable may be relevant. For example at least one from the following list of variable state variables shall be taken into account: 1) a temperature of the sealing element or seal, in particular detected by means of a temperature sensor and/or by means of a of a temperature model, 2) a temperature in the interior and/or in the exterior, in particular detected by means of a temperature sensor and/or a temperature model, 3) an inclined position of the vehicle, in particular detected by of a high-resolution acceleration sensor, 4) an angle of aperture of the door, in particular detects by means of a position sensor, 5) a compressed air volume in an interior space delimited by the door, in particular detected by communication with a control unit of an air conditioning/ventilation unit, of the other vehicle doors and/or the window regulators, 6) a degree of ageing of the sealing element or seal, in particular detected by means of an ageing model for the sealing element and the use of a timer to determine the age.

Thus, the closing device can determine the most important influencing factors in addition to usual or previously determined closing parameters (i.e., last determined value of the closing parameter(s)).

In order to be able to dispense with a separate temperature sensor, a determination of the seal temperature may be carried out by an approximation calculation depending on a detected temperature in the interior and/or on a detected temperature in of the exterior or environment.

Depending on the influencing factor or factors for a given application, some state variables are determined and taken into account that can be defined as a constant. Such constant state variables can include at least one of the following: 1) a material and/or a nominal geometry of the seal or sealing element, in particular selected from an material model and/or a geometry model, 2) a nominal geometry and/or a real geometry of the door and/or the door frame, in particular read out from a tolerance model of the door and/or door frame.

To prevent the door and the door frame or opening from being subjected to a high closing moment and/or a high closing speed, the compressibility of the air volume is adapted or adjusted, by an opening (e.g., short-term) of a recirculation or ventilation valve of an interior ventilation system of the vehicle or an opening (e.g., short-term) of a vehicle or a window of the vehicle in addition to the adjustment of the value of the closing parameter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1B illustrate schematic plan views of a door system including a door opening and a door in an open position and a closed position with a closing device according to aspects of the disclosure;

FIGS. 2A-2B illustrate schematic plan views of another door system including a door opening and a door in an open position and a closed position with a closing device as well as a soft close unit according to aspects of the disclosure;

FIG. 3 illustrates a schematic plan view of a motor vehicle with four door systems according to aspects of the disclosure;

FIG. 4 shows a schematic rear view of the motor vehicle of FIG. 3 parked in an inclined position according to aspects of the disclosure; and

FIG. 5 illustrates steps of a method of closing the door according to aspects of the disclosure.

### DETAILED DESCRIPTION

In general, at least one example embodiment of a closing device for for closing a door on a door opening of a door system of a motor vehicle and corresponding method of operation will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

While the disclosed closing device and method are described below in the context of electromechanically actuated vehicle doors, it should be understood that the closing device and corresponding method may alternatively be used for doors on and/or in buildings. In both cases, the closing device controls movement of the door to separate and delimit an interior space from an exterior space. In addition, the invention can also be used with other doors or closing members in a variety of applications, such as, but not limited to hydraulically actuated doors.

During operation of actuated vehicle doors, closing forces and torques can vary greatly in different operating situations. In some known systems, a planned maximum required closing torque for the door can determined, which is then utilized by the system when it is determined that the user wishes to close the door. If necessary, a safety margin can also be applied to ensure reliable closing of the door in every operating case of the vehicle.

Door-closing parameters may be set and used by the system for reference. Such parameters can include, for example, a closing moment and a closing speed that can be used to ensure a sufficient closing force with a known door weight. The objective of the closing process is normally for these known vehicle doors, to close the door against all resistance forces to such an extent that the door can be used with an additional soft close unit, which then engages the door, which is moved to a final locking position.

One approach is to move the door at a sufficient speed or with a sufficient closing torque for all intended applications. Yet, such an approach has various disadvantages with regard to undesirable noise during the closing process (e.g., door slams) and may also lead to increased wear of the system. In addition, the actuation and movement of the door typically involves a large number of components that must properly function together to provide expected operation.

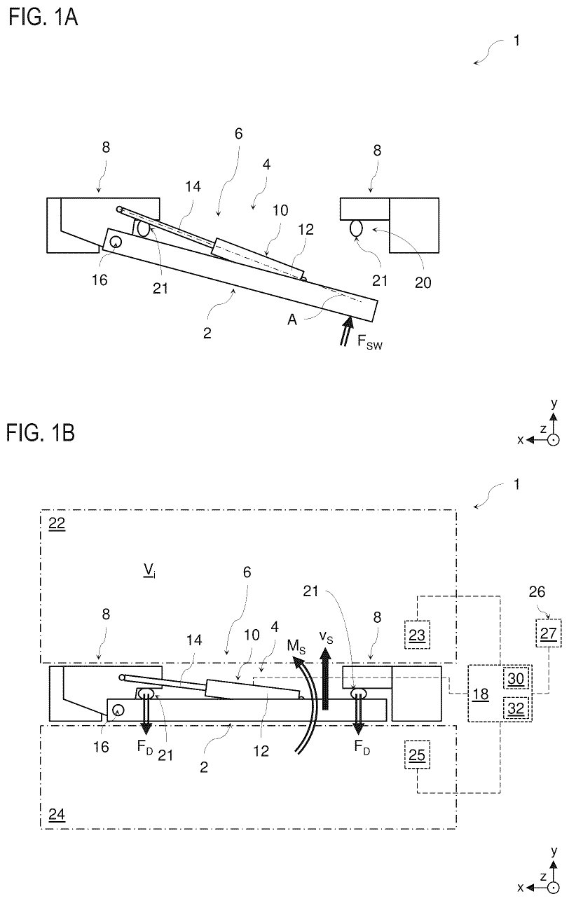

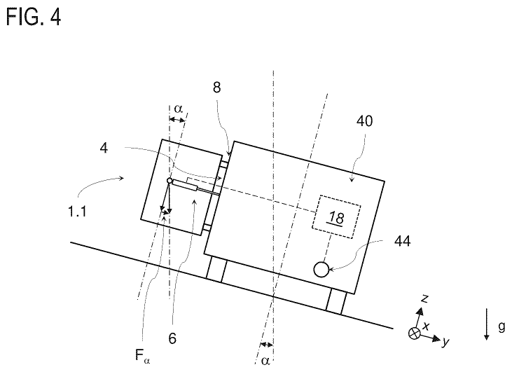

FIGS. 1A-1B show a door system 1 with one door 2 and one door opening 4 as well as with a closing device 6 according to a first exemplary embodiment. As shown, door system 1 is a side door of a motor vehicle that is moveable relative to a side portion 8 of the vehicle 40. Only the side portion 8 of the vehicle 40 that forms the door opening 4 is shown in FIGS. 1A-1B, however, the entire vehicle 40 can be seen in FIGS. 3 and 4.

The closing device 6 includes an electric motor that is part of a door drive 10. The door drive 10 includes a motor body 12 coupled to the door 2. The closing device 6 also includes a drive rod 14 of the door drive 10 configured to move the door 2 that is attached to and edge of the door opening 4 (i.e., the side portion 8), for example. Depending on the extension of the drive rod 14 along a drive axis A due to movement of the electric motor of the door drive 10, the door 2 can be moved about a swivel bearing 16 of the door system 1 to open or close the door 2. It should be appreciated that other types of door drives 10 are contemplated as well.

Between the door 2 and the door opening 4, there is a contact surface, which can extend all the way around the entire contact surface. A seal 20 is formed along this contact surface. The seal 20 can, for example, be formed by a sealing element or gasket 21, which is adapted to seal the opening. Thus, the sealing element 21 is disposed around the door opening 4 between an interior space 22 and an exterior space 24 and is configured to be elastically deformed (i.e., compressed) when the door 2 is closed and in contact with the edge of the door opening 4 (e.g., the side portion 8 of the vehicle 40).

The closing device 6 also has a controller 18 (e.g., microcontroller or microprocessor) in communication with the electric motor of the door drive 10 for closing the door 2 in response to a detected closing request. The user can communicate the closing request to the controller 18, for example, by means of a control element (e.g., button or switch) or by means of a manually applied closing force F_{SW} to the door 2, which may be detected through movement of the motor of the door drive 10 and communicated to the controller 18.

In addition, the closing device 6 includes an interior temperature sensor 23 arranged in the interior 22 of the vehicle and an exterior temperature sensor 25 arranged on the exterior 24 of the vehicle. The two temperature sensors 23 and 25 are connected with the controller 18 to enable energy transmission and/or communication of sensor values that each temperature sensor 23, 25 detects. The controller 18 is also connected with a database or memory 26. Operating models 27 of the motor vehicle, and in particular of the door system 1 are stored therein.

Additionally, the controller 18 includes a condition monitoring unit 30 (e.g., a software or hardware module of controller 18) that is configured to, for example, use a current value of a current temperature and a current state of ageing of the sealing element 21 and to determine the stiffness to be expected from it. The stiffness of the sealing element 21 can be estimated using the temperature sensors 23, 25 and/or by resorting to the operating model 27.

The controller 18 also has a state calibration unit 32 (e.g., a software or hardware module of controller 18), which is configured to provide a basic stiffness of the sealing element 21 based on stored characteristics of the sealing material, and if necessary also based on a combination of actual geometries of door 2 and door opening 4 within respective tolerance ranges.

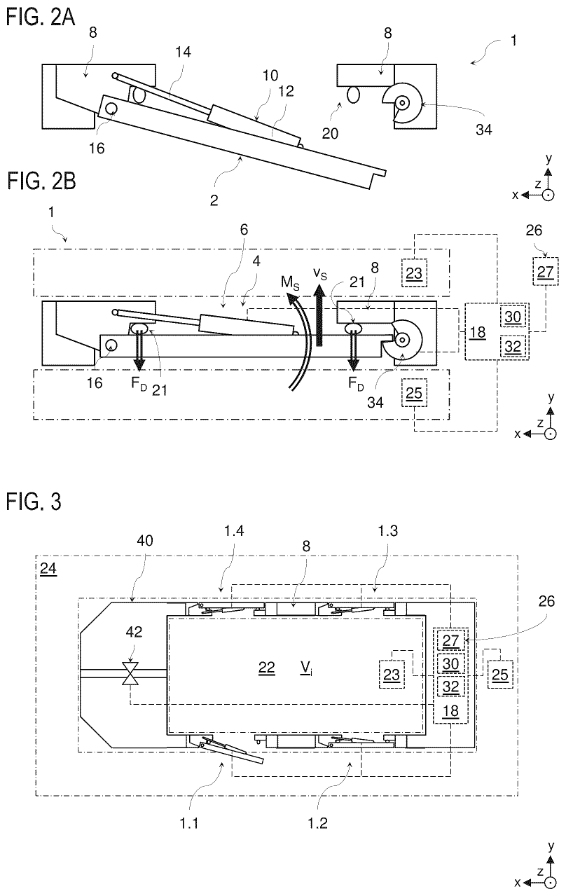

FIGS. 2A-2B show a second exemplary door system 1 which differs from the one described in FIGS. 1A-1B, in particular on one side of the door opening 4, a soft-close unit 34 is arranged to lock the door in a closing position. In this case, closing door 2 only needs to be partially closed so that soft close unit 34 is able to detect that the door 2 is to be closed and the soft close unit 34 will be able to finish the closing movement and locking of the door 2 in a desired closed position (in a usual manner). Various operating positions and soft close units 34 may be utilized to accomplish the function of the soft close unit 34.

FIG. 3 shows a motor vehicle 40 according to an aspect of the disclosure with four door systems 1.1, 1.2, 1.3 and 1.4. Each of the door systems 1.1, 1.2, 1.3, 1.4 can for example be the door system 1 described in FIGS. 1A-1B.

The motor vehicle 40 has a controller 18 which, in addition to the functions of controller 18 for each of the door systems 1.1 to 1.4 described above (e.g., for the controller of FIGS. 1A-1B), is also configured to open and close at least one air recirculation valve 42 of a vehicle ventilation system. The controller 18 can also sense whether, at a certain point in time the air recirculation valve 42 is open or closed.

In the example shown in FIG. 3, the control of the closing parameters for the door 2 of the door system 1.1 (and also for the other doors 2 of the other door systems 1.2, 1.3. 1.4) is additionally dependent on a compressed air volume Vᵢ in the interior 22 of the vehicle 40. If the user wishes the door 2 to be closed, the controller 18 determines whether the recirculation valve 42 is closed. For the purposes of the description of this disclosure, it is assumed that the interior 22 is closed when the recirculation valve 42 is closed. So, if the doors 2 of the door systems 1.1, 1.2, 1.3. 1.4 are closed and air recirculation valve 42 is closed, the interior 22 is sealed pressure-tight (any windows are closed). In addition, for the sake of simplicity, the opening condition of any windows are not taken into account here; however, such factors or other additional factors can also be considered by the controller 18, according to aspects of the disclosure. Thus, if door 2 (e.g., of door system 1.1) is to be closed with the interior 22 being sealed, the door 2 must not only the work of deformation against the sealing element 21, but also the much greater work of compressing the air volume Vᵢ of the interior 22 of the vehicle 40. Consequently, in the case of the closed recirculation valve 42, a significantly higher closing torque must be commanded by the controller 18 compared to if the recirculation valve 42 was open instead. Accordingly, the controller 18 can also be configured to open the recirculation valve 42 when the last opened door 2 is closed. Consequently, the opening of the air recirculation valve 42 helps reduce or eliminate any required compression of the air volume Vᵢ in the interior 22.

In FIG. 4 the motor vehicle 40 from FIG. 3 is shown in an inclined parking position. Such an inclined parking position of the vehicle 40 influences the required actuation force F_{α} of door 2 during closing. If, as shown in FIG. 4, the vehicle 40 is on an inclined road, the door 2 of door system 1.1 is also inclined towards the vehicle 40 (inclination angle α), so less force F_{α} is required from the door drive 10 when closing the door 2. In the case of an inclination in the other direction, more force F_{α} by the door drive 10, on the other hand would be necessary. So, as the vehicle 40 is increasingly inclined in the opposite direction to the closing direction, the door drive 10 must increasingly move with greater force F_{α} or closing torque according to the increasing inclination. This relationship can be incorporated into the control of the closing parameters such as the M_{S} or the closing speed V_{S} by the controller 18, through an acceleration sensor 44 in communication with the controller 18, in particular a high-resolution acceleration sensor 44 for accelerations in all three spatial dimensions. So, the controller can determine the inclination angle α using readings from the acceleration sensor 44. Using the acceleration sensor 44, the controller 18 can control the door drive 10 with proper closing parameters (e.g., applied closing force), taking into account the inclined position of the vehicle, so as not to increase the closing noise unnecessarily.

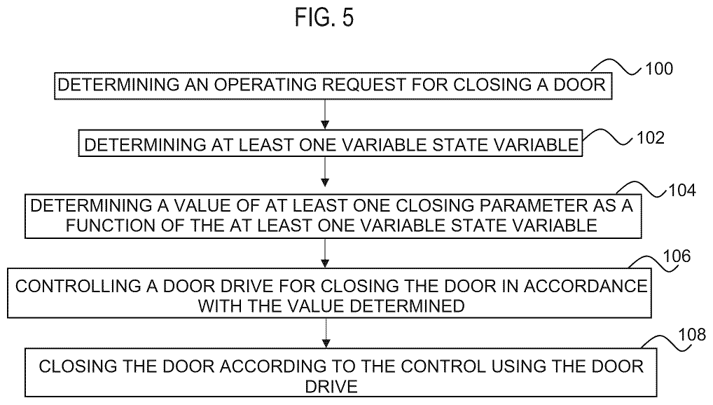

As best shown in FIG. 5, steps of an exemplary method for closing the door 2 at the door opening 4 using the closing device 6 are provided. First, an operating request for closing the door 2 is detected using the controller 18. Thus, the method includes the step of 100 determining an operating request F_{SW} for closing the door 2. This can be done, for example, by the user of the vehicle manually applying a closing force F_{SW} to the door 2, which can be detected and adjusted by the controller 18 through the associated movement of the door rod 14 relative to the motor body 12.

The method proceeds with the step of 102 determining an amount of at least one variable state variable. For example, to determine the sealing force F_{D} required for the door drive 10 to compress the sealing element 21 while closing the door 2 to a desired closing position, the at least one variable state variable (e.g., temperature) is measured using temperature sensors 23 and 25 (e.g., based on empirical values in the operating model 27 with regard to a seal temperature as a function of a certain combination of indoor temperatures and a certain outdoor temperature). So, the current seal temperature (e.g., a first variable state variable) is determined. In addition, a current seal age can be determined using a timer (e.g., a second variable state variable). From the variable state variables of the seal temperature and seal age, a sealing stiffness is determined, again with recourse to the operating model 27. This is done, for example, using the condition monitoring unit 30.

The method continues with the step of 104 determining a value of at least one closing parameter M_{S}, V_{S} as a function of the at least one variable state variable (e.g., using the controller 18 that includes the condition monitoring unit 30). Thus, depending on the determined characteristics of the variable state variables mentioned above (or readings by acceleration sensor 44, for example), closing parameters including the required closing torque M_{S} and/or the required closing speed V_{S} are determined by the controller 18 in order to reliably move the door 2 against the resistance of the of the sealing element 21.

Constant state variables may also used in the determination of closing torque M_{S} and/or the required closing speed V_{S} by the controller 18. Specifically, the tolerance situation of door 2 and door opening 4 to each other and the material of the sealing element 21 can affect the appropriate values for the closing parameter(s). Thus, the controller 18 can determine such constant state variables as a function of the recorded characteristics. Thus, the values for the closing parameter(s) are adapted as a function of the various variable and constant state variables.

Based on the values determined for the closing parameter(s), the controller 18 controls the door drive 10. So, the method proceeds with the step of 106 controlling a door drive 10 for closing the door 2 in accordance with the determined value (i.e., closing parameters) determined using the controller 18. Thus, the next step of the method is 108 closing the door 2 according to the control using of the door drive 10. As discussed, the controller 18 may also control the recirculation valve 42 as needed.

The operating request and the characteristic of the state variable(s) are determined many times per second by the controller 18 and the closing of door 2 is controlled in real time by building on a last determined value of the closing parameter(s). In each case, an adapted value of the closing parameter(s) is determined for each of the state variables, depending on from the last determined operating request and from the last determined characteristic.

### LISTING OF ELEMENTS

1 Door system
2 Door
4 Door opening
6 Closing device
8 Side portion of vehicle body
10 Door drive
12 Motor body
14 Actuators
16 Swivel bearing
18 Controller
20 Seal
21 Sealing element
22 Interior
23 Interior temperature sensor
24 Exterior
25 Exterior temperature sensor
26 Database or memory
27 Operating model
30 Condition monitoring unit
32 State calibration unit
34 Soft close unit
40 Motor vehicle
42 Air recirculation valve
44 Acceleration sensor
A Door drive axis
F_{SW} Applied force to express the operating request
F_{D} Sealing force
M_{S} Closing torque
V_{S} Closing speed
Vᵢ Air volume in the interior
α Angle of inclination of the vehicle
F_{α} Additional closing force due to inclined position

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A method for closing a door at a door opening, comprising the steps of:
determining an operating request for closing the door;
determining an amount of at least one variable state variable;
determining a value of at least one closing parameter as a function of the at least one variable state variable using a controller including a condition monitoring unit;
controlling a door drive for closing the door in accordance with the value of the at least one closing parameter; and
closing the door according to the control using the door drive.

2. The method as set forth in claim 1, further including the steps of:
determining the operating request and characteristics of the at least one variable state variable multiple times per second; and
utilizing a last determined value of the at least one closing parameter along with the operating request and characteristics of the variable state variable to determine an adjusted value of the at least one closing parameter to close the door in real time.

3. The method as set forth in claim 2, wherein the method further includes the steps of:
recording a characteristic of at least one at least constant state variable; and
determining the value of the of the at least one closing parameter based on the characteristic of the at least one constant state variable.

4. The method as set forth in claim 3, wherein the at least one constant state variable includes a plurality of constant state variables and the at least one variable state variable includes a plurality of variable state variables and the value of the at least one closing parameter depends on the characteristics of the plurality of variable state variables and the plurality of constant state variables.

5. The method as set forth in claim 4, wherein the at least one constant state variable is chosen from a group consisting of a material or a nominal geometry of a sealing element of the door, and a nominal geometry or a real geometry of the door or the door opening.

6. The method as set forth in claim 1, wherein the at least one closing parameter includes a closing speed or a closing torque.

7. The method as set forth in claim 1, wherein the at least one variable state variable is chosen from a group consisting of a temperature of a sealing element of the door, a temperature in an interior or an exterior of a vehicle, an inclined position of the vehicle, an opening angle of the door, an air volume to be compressed in a space delimited by the door, and a degree of ageing of the sealing element.

8. The method as set forth in claim 7, further including the step of calculating the temperature of the sealing element as a function of a sensed temperature in the interior or a sensed temperature in the exterior.

9. The method as set forth in claim 8, wherein the method further includes adjusting the value of the at least one closing parameter based on a compressibility of the air volume.

10. The method of claim 1, further comprising monitoring the door moving and adapt the at least one closing parameter based on results of monitoring the door moving.

11. A door configured to swivel relative to a motor vehicle body of a vehicle between an opened position and a closed position, the door comprising:
a door drive having an electric motor and a drive rod extendable along a drive axis in response to movement of the electric motor, the drive rod connected to the motor vehicle body; and
a controller in communication with the electric motor, the controller adapted to detect a user manually applied closing force to the door and control the electric motor to adjust the user manually applied closing force such that the user can close the door with a minimal force.

12. The door of claim 11, wherein the controller is configured to determine a closing torque to move the door against forces resisting door motion and adjust the closing torque during operation of the door drive.

13. The door of claim 12, wherein the controller is configured to monitor the door opening to determine the closing torque.

14. The door of claim 11, wherein the controller is configured to control the electric motor based on at least one state variable of the door drive.

15. The door of claim 11, wherein the controller is configured to control the electric motor based on at least one state variable of the door.

16. The door of claim 11, wherein the controller is configured to monitor an acceleration sensor for detecting a spatial orientation of at least one of the door or the vehicle.

17. The door of claim 11, wherein the controller configured to detect the user manually applied closing force by detecting a movement of the door drive.

18. The door of claim 11, wherein the controller is configured to detect the user manually applied closing force and determine a state variable simultaneously with the electric motor controlled to close the door.

19. The door of claim 18, wherein the controller is configured to determine a value of at least one closing parameter for each determined state variable.

20. A door drive system for moving a door connected to a vehicle body using a swivel bearing, the door drive system comprising:
a door drive having an electric motor and a drive rod linearly extendable along a drive axis in response to movement of the electric motor, the drive rod connected to the vehicle body; and
a controller in communication with the door drive, the controller adapted to:
detect a user manually applied closing force to the door;
determine factors influencing a required closing torque of the door drive to move the door;
monitor the door closing by the user manually applied closing force;
adapt the required closing torque simultaneously with monitoring the door closing; and
control the electric motor to compensate for resistance forces against door closing due to state variables such that the user can close the door against the resistance forces with a minimal force.
